(19) United States
(12) Patent Application Publication
(10) Pub. No.: US 2014/0012551 A1
(43) Pub. Date: Jan. 9, 2014

(54) System and Method for Determining Thermodynamic Parameters

(71) Applicants: Christopher Laughman, Waltham, MA (US); Yiming Zhao, Somerville, MA (US); Daniel Nikolaev Nikovski, Brookline, MA (US)

(72) Inventors: Christopher Laughman, Waltham, MA (US); Yiming Zhao, Somerville, MA (US); Daniel Nikolaev Nikovski, Brookline, MA (US)

(21) Appl. No.: 13/541,612

(22) Filed: Jul. 3, 2012

(51) Int. Cl. G06F 17/10

(52) U.S. Cl. 703/2

(57) ABSTRACT

A method determines a value of a thermodynamic parameter of a substance based on a set of secondary manifolds, wherein each secondary manifold represents a mapping among a combination of thermodynamic parameters of the substance, and wherein the mapping is based on a primary manifold representing a mapping between a pair of thermodynamic parameters and a thermodynamic potential. A particular secondary manifold is selected from the set of secondary manifolds based on particular thermodynamic parameters, wherein the particular secondary manifold is a mapping between the particular thermodynamic parameters and the thermodynamic parameter, and the value of the thermodynamic parameter is determined based on the particular secondary manifold and values of the particular thermodynamic parameters.

### FIELD OF INVENTION

This invention relates to determining thermodynamic parameters of a substance, and more particularly to determining a value of the thermodynamic parameter based on a thermodynamic potential of the substance.

### BACKGROUND

Simulation, optimization, estimation, and control techniques have become increasingly important for maintaining and improving the safety and performance of various industrial systems, such as chemical process systems, refinery systems, power generation systems, refrigeration and air or natural gas liquefaction systems. The simulation, optimization, estimation and control of these systems require thermodynamic parameters substances involved in the thermodynamic processes. Unfortunately, some thermodynamic parameters are difficult or expensive to measure, and some of these thermodynamic parameters cannot be measured at all. Thus, the efficient determination of thermodynamic parameters is critical for simulating, and especially, the real time operation and control of these systems.

The thermodynamic state of a substance, such as fluid, can be uniquely determined by an appropriate set of thermodynamic parameters. After the thermodynamic state of the fluid is determined, other thermodynamic parameters, e.g., density, specific enthalpy, or specific entropy, can be determined theoretically with an appropriate equation of state (EOS). However, the EOS theory does not specify how to perform the determination.

A variety of methods for determining fluid thermodynamic parameters are known. Some methods, such as the Van der Waals equation, represent the parameters of some fluids. However, the parameters are inaccurate. Other, more complex EOS is able to describe the thermodynamic behavior of fluids more accurately.

For example, one conventional method for determining fluid thermodynamic parameters includes EOS representations for a wide variety of fluids. That method can perform a wide range of thermodynamic parameter determinations for both pure fluids and nearly arbitrary mixtures of fluids. However, that method is designed for the exploration and determination of the thermodynamic parameters of fluids, rather than for the integration of working fluid parameter determinations for simulation or control of thermodynamic processes. For example, for a simulation that determines thousands of parameters, the time required of that method limits the overall simulation speed.

Another conventional method uses pre-determined lookup tables. For example, a number of air-conditioner simulations use pre-determined lookup tables, where the desired parameters (e.g., specific enthalpy) are determined offline from a set of measured variables (e.g., temperature and pressure) before the simulation, and then the simulation looks up the corresponding parameter value at runtime. Predetermined lookup tables have the advantage of being very fast, but typically have an accuracy which is strongly dependent upon a sampling density of the parameter.

Accordingly, there is a need for thermodynamic parameter calculation methods, which are both computationally efficient and accurate. Moreover, the consistency of these parameter determinations is also essential. For example, the specific enthalpy ĥ of a fluid can be determined as a function of measurements of temperature T and pressure p, where “̂” denotes that this parameter is determined rather than measured. This new value of ĥ can then be used with the pressure p, to determine the temperature T. For a number of applications, it is essential, that the resulting temperature value determined using ĥ and p is substantially identical to the original measurement T.

Unfortunately, conventional methods produce a nonzero residual between these two values. Because a variety of different measurements are used in these simulations for many different computations, these determinations are not consistent, i.e., these parameter determination methods do not minimize the size of the residual.

For example, several methods, see, e.g., Ding et al (2005, 2009) and Kunic et al (2009), use a set of mappings. Each mapping determines thermodynamic parameters, as determined by construction of the mapping. To compute other thermodynamic parameters, excluded from the mappings, new mappings must be constructed. However, the consistency between these different mappings is not ensured, and the co-existence of multiple representations increases memory size, and computation complexity.

Usually, the conventional methods for determining the thermodynamic parameters fit functional forms to thermodynamic potentials to establish the fundamental EOS. The fundamental EOS enables determining some state functions via differentiation. For example, the substance, such as fluid, can be characterized in terms of the Helmholtz energy A(T, ρ), which is represented by a fundamental EOS. A few thermodynamic parameters that can be calculated from the density ρ and the temperature T using the fundamental EOS for the Helmholtz energy are as follows:

$$p = {{ρ}^{2} ( \frac{\partial a}{\partial ρ} )}_{T}$$

$$S = - {( \frac{\partial a}{\partial T} )}_{ρ}$$

$$u = a + Ts$$

$$h = a + p / ρ$$

$${c}_{v} = {( \frac{\partial u}{\partial T} )}_{ρ}$$

$${c}_{p} = {( \frac{\partial h}{\partial T} )}_{p}$$

where a denotes the specific Helmholtz energy, p is the pressure, S is the entropy, u is the internal energy, h is the enthalpy, cᵥ is the isovolumetric specific heat, cₚ is the isobaric specific heat.

Although the above equations can be used to determine thermodynamic parameters using a pair of values of ρ and T, it is difficult to determine a thermodynamic parameter when the pair of values of the thermodynamic parameters are not ρ and T. The general solution to such a problem relies on an iterative process. For example, if the pair of thermodynamic parameters includes ρ and T, and the corresponding value h of the enthalpy is to be determined, then the computation starts with the pair of ρ and T as an initial values, and iteratively updates ρ and T such that the determined values including the pressure \hat{p} and the enthalpy using the fundamental EOS match the given values p and h. In particular, the residuals p−\hat{p} and h−ĥ are used to improve the accuracy of the pair ρ and T values iteratively until the magnitude of these residuals are reduced below a predetermined tolerance. If square root finding-procedures are properly implemented and the tolerance is small enough, then by the time that the iteration terminates, \hat{p} and ĥ values are considered sufficiently close to the true values h and p.

The major drawback of the current fundamental EOS approach for thermodynamic parameter determinations is the complex computation associated with the evaluations of the fundamental EOS, as well as its derivatives, which are further increased by the iteration process.

### SUMMARY OF THE INVENTION

It is an object of some embodiments of an invention to provide a method for determining a value of a thermodynamic parameter of a substance, such as a single component substance in a liquid or a gas phase. It is a further object of some embodiments to provide a method for mutually consistent determination of multiple thermodynamic parameters.

It is a further object of some embodiments of the invention to provide a method for improving efficiency of thermodynamic parameter determinations for the simulation, optimization, estimation, or control of a desired thermodynamic process.

It is a further object of some embodiments of this invention to provide a method to improve an efficiency of thermodynamic parameter determinations by accomplishing certain procedures offline based on a proper thermodynamic potential to generate and store data for efficient and mutually consistent real time determinations.

It is a further object of some embodiments of the invention to provide a method for determining phase of the substance efficiently using predetermined liquid-vapor phase transition data generated, e.g., offline.

Various embodiments of the invention are based on a general realization that various thermodynamic parameters of a substance can be determined based on one of thermodynamic potentials of the substance, such as the internal energy, enthalpy, Helmholtz energy, or Gibbs free energy. Moreover, some embodiments are based on a specific realization that if the thermodynamic parameters are determined based on the one of thermodynamic potentials, the thermodynamic parameters are mutually consistent.

For example, if the thermodynamic parameters are mutually consistent, values of a thermodynamic parameter determined based on different combinations of mutually consistent thermodynamic parameters using appropriate equation of state (EOS) are substantially identical, which means that the difference between these determined values for the same thermodynamic parameter are caused only by the accuracy of the calculation, which is typically sufficiently small. Hence in general these results can be considered identical for practical applications. Similarly, if the thermodynamic parameters are mutually consistent, a thermodynamic parameter or derivatives of that thermodynamic parameter determined based on the pair of other thermodynamic parameters can then be used to accurately re-compute the pair of thermodynamic parameters.

By properly selecting the thermodynamic potential and establishing the mappings between thermodynamic parameters using the same thermodynamic potential, a number of the iterative determinations required by the fundamental EOS can be reduced. Moreover, the mappings can be predetermined offline, and appropriate mapping can be selected in real time based on, e.g., measurements of particular thermodynamic parameters.

Accordingly, one embodiment discloses a method for determining a value of a thermodynamic parameter of a substance. The method includes acquiring a set of secondary manifolds, wherein each secondary manifold represents a mapping among a combination of thermodynamic parameters of the substance, and wherein the mapping is based on a primary manifold representing a mapping between a pair of thermodynamic parameters and a thermodynamic potential; selecting a particular secondary manifold from the set of secondary manifolds based on particular thermodynamic parameters, wherein the particular secondary manifold is a mapping between the particular thermodynamic parameters and the thermodynamic parameter; and determining the value of the thermodynamic parameter based on the particular secondary manifold and values of the particular thermodynamic parameters. The steps of the method can be performed by a processor.

For example, the substance can be a single phase substance, and the method can include testing a correspondence of the values of the particular thermodynamic parameters to the phase of the substance. In some implementations of the method, the primary manifold can be determined based on a model of the substance; and the secondary manifold can be generated by transforming the primary manifold into coordinate system of the combination of the thermodynamic parameters using, e.g., a theory of thermodynamics. The transforming can be non-iterative, and the thermodynamic potential can be selected from a group consisting of a Helmholtz energy, a Gibbs free energy, an enthalpy, and an internal energy.

Also, the method can include measuring the values of the particular thermodynamic parameters. The values of the set of secondary manifolds can be mutually consistent.

Another embodiment discloses a method for determining a value of thermodynamic parameter of a substance including generating, based on a model of the substance, a primary manifold of a thermodynamic potential of the substance; transforming the primary manifold into a set of secondary manifolds using a theory of thermodynamics, wherein each secondary manifold represents a mapping among a combination of thermodynamic parameters of the substance; and determining the value of the thermodynamic parameter based on measurements of thermodynamic parameters and at least one secondary manifold.

Yet another embodiment discloses a thermodynamic system having a working fluid. The system includes at least one sensor for measuring particular thermodynamic parameters to produce at least one measurement; a memory storing a set of secondary manifolds, wherein each secondary manifold represents a mapping among a combination of thermodynamic parameters of the substance, and is generated based on a primary manifold of a thermodynamic potential of the substance; and a processor for determining a value of a thermodynamic parameter based on the measurement, the primary manifold and at least one secondary manifold.

### DEFINITIONS

A fluid is a substance that continually deforms (flows) under an applied shear stress. The phases of the matter in a fluid include liquids, gases, plasma. Within the scope of this invention, a fluid refers only to matters in gas and liquid phases.

Intensive quantities characterizing a substance are those whose values do not depend on the amount of substance in the system

Extensive quantities characterizing a substance are those whose values depend on the amount of substance in the system.

Intensive quantities that determine the state of a thermodynamic system are called thermodynamic parameters of the state of the system. The individual parameters are also known as state variables, thermodynamic parameters, and state parameters.

A thermodynamic state is the macroscopic condition of a thermodynamic system as described uniquely by a set of thermodynamic parameters. The state of any thermodynamic system can be uniquely described by a set of thermodynamic parameters, such as temperature, pressure, density, composition, independently of its surroundings or history.

Thermodynamic potentials are a particular set of state variables which have the dimension of energy. Thermodynamic potentials include internal energy, the enthalpy, the Helmholtz free energy, and the Gibbs free energy.

Each thermodynamic potential is defined as a function of a particular set of thermodynamic parameters, which are known as natural variables for the thermodynamic potential.

### BRIEF DESCRIPTION OF THE DRAWINGS

FIG. 1A is a schematic of a primary manifold according to some embodiments of an invention;

FIG. 1B is a schematic of a transformation of the primary manifold for generating secondary manifolds according to some embodiments of the invention;

FIG. 1C is a schematic of the relations between four thermodynamic potentials, as well as the natural variables for each of these potentials according to some embodiments of the invention;

FIG. 1D is a block diagram of a system and a method for determining a value of a thermodynamic parameter of a substance according to some embodiments of the invention;

FIG. 2 is a block diagram of the offline computations and procedures according to one embodiment of the invention; and

FIG. 3 is a block diagram of the real time computations and procedures according to some embodiments of the invention.

### DETAILED DESCRIPTION OF THE INVENTION

Various embodiments of the invention are based on a general realization that various thermodynamic parameters of a substance can be determined based on one of thermodynamic potentials of the substance, such as the internal energy, enthalpy, Helmholtz energy, and Gibbs free energy. Moreover, some embodiments are based on a specific realization that if the thermodynamic parameters are determined based on the thermodynamic potential, than the thermodynamic parameters are mutually consistent.

As referred herein, the mutually consistent values of thermodynamic parameters are such parameters that satisfy equation of state (EOS) and any thermodynamic relations derived from the EOS using theory of thermodynamics.

By selecting the appropriate thermodynamic potential and establishing the mappings between thermodynamic parameters using the same thermodynamic potential, a number of the iterative determinations required by the fundamental EOS can be reduced. Moreover, the mappings can be determined offline, and appropriate mapping can be selected in real time based on, e.g., measurements of particular thermodynamic parameters.

Some embodiments of the invention use a model-based method to establish a first mapping from a set of thermodynamic parameters of a single phase fluid substance to a thermodynamic potential using an appropriate type of manifold, called a primary manifold. The primary manifold is than transformed, e.g., mapped to pairs of various thermodynamic parameters based on the theory of thermodynamics. The mappings between thermodynamic parameters based on the primary manifold are referred herein as secondary manifolds. Due to the particular form of the primary manifold, the secondary manifolds provide mutually consistent, accurate, efficient, and sometimes non-iterative evaluation of the mappings between thermodynamic parameters.

Various embodiments can be implemented in either software or hardware for the efficient and accurate computation of thermodynamic parameters, which are used in the modeling, simulation, control, estimation, and optimization of thermodynamic processes.

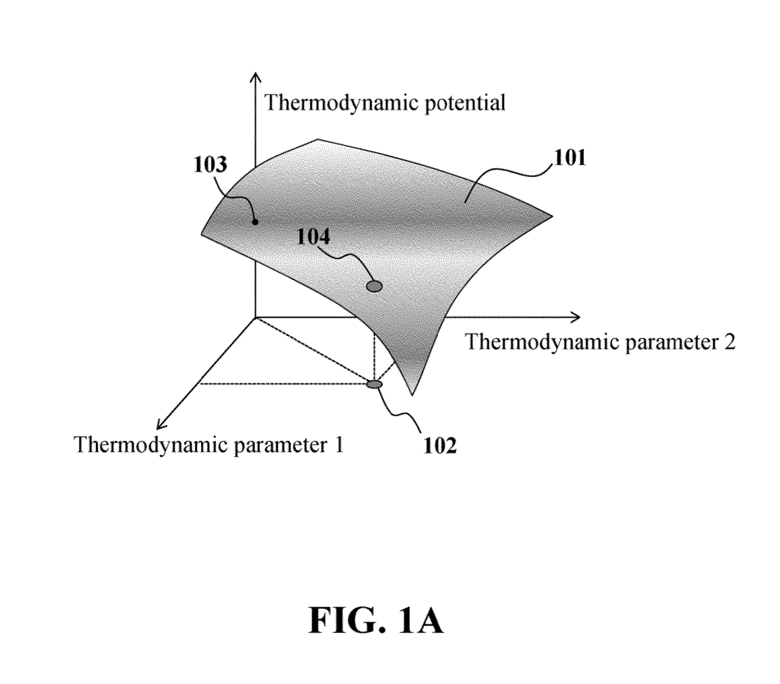

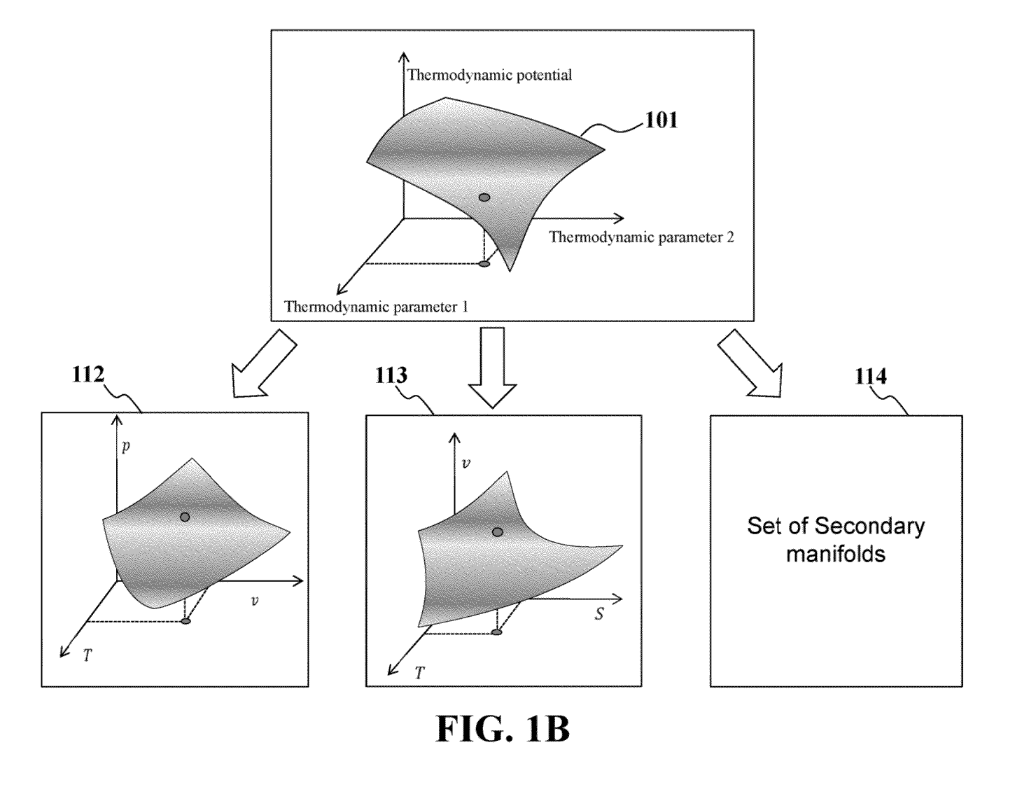

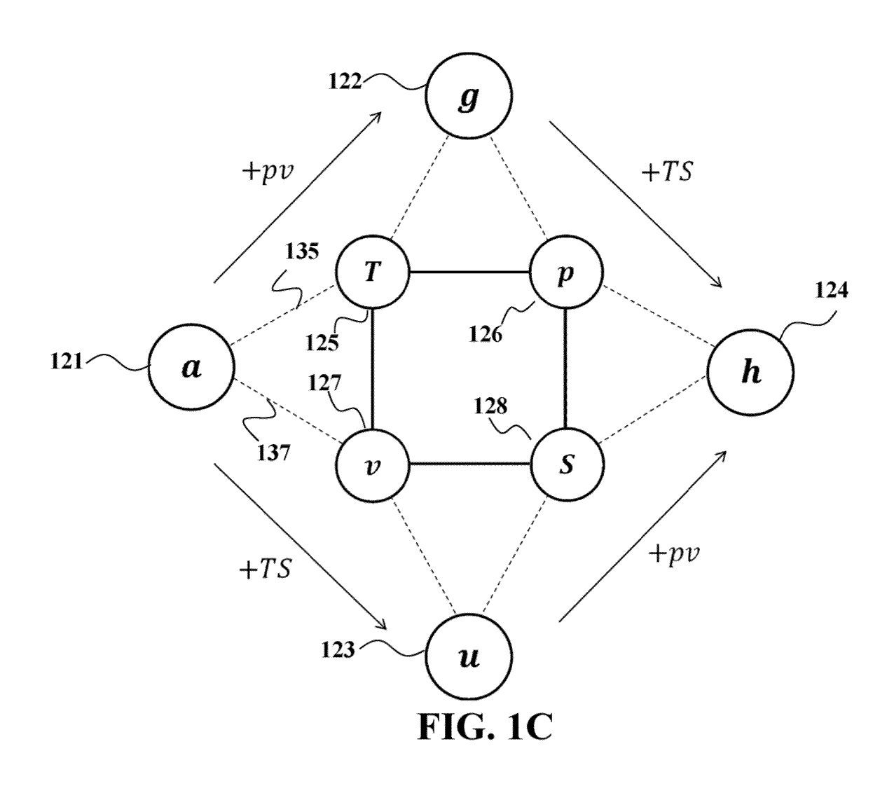

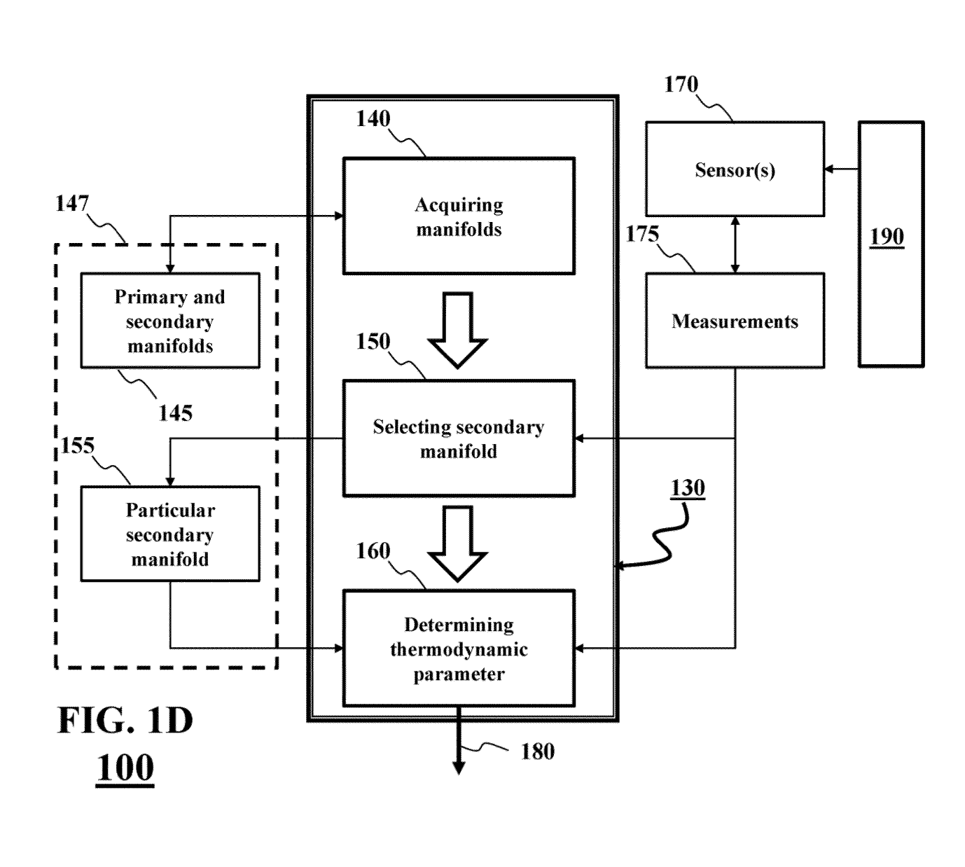

FIG. 1A shows a schematic of the mapping from a set of thermodynamic parameters to a thermodynamic potential referred herein as a primary manifold. In one embodiment, the primary manifold 101 is generated based on a thermodynamic model of the substance. The input 102 of the mapping includes at least two thermodynamic parameters. The output 103 of the mapping is a value of the thermodynamic potential which is uniquely determined by the input. The primary manifold 101 relates the unique thermodynamic potential value 103 to the set of thermodynamic parameters 102 via a location 104 on the manifold, which is uniquely determined by the input 102.

After the primary manifold is generated, additional mappings, i.e., the set of secondary manifolds, can be generated based on the primary manifold according to the theory of thermodynamics.

FIG. 1B shows schematically a transformation of the primary manifold 101 generating the secondary manifolds 112-114. Each secondary manifold establishes the mapping from the input as a set of thermodynamic parameters to the output that includes at least one thermodynamic parameter. As an example, the secondary manifold 112 represents the mapping from the temperature T and specific volume v to the pressure p. As another example, the secondary manifold 113 represents the mapping from the temperature T and entropy S to the pressure T. When the primary manifold is established properly, all mappings defined by the additional manifolds can be evaluated more efficiently than the same type of determinations using the fundamental EOS approach and ensure that the thermodynamic parameters of the primary and the secondary manifolds are mutually consistent.

FIG. 1C shows schematic of the relations between four thermodynamic potentials, as well as the natural variables for each of these potentials. The thermodynamic potentials include the Helmholtz energy α (121), the Gibbs free energy g (122), the enthalpy h (124), and the internal energy u (123). The thermodynamic state variables include the temperature T (125), the pressure p (126), the specific volume v (127), and the entropy S (128).

Each thermodynamic potential is defined as a function of a particular set of thermodynamic parameters, which are known as natural variables for the thermodynamic potential. In FIG. 1C, each thermodynamic potential is connected to two natural variables by two dashed lines. For example, the Helmholtz energy 121 is connected to temperature T125 and specific volume v 127 by dashed lines 135 and 137 to illustrate that the thermodynamic parameters T and v are the natural variables for the Helmholtz energy α.

Similarly, entropy S 128 and the specific volume v 127 are the natural variables for the internal energy u 123. The entropy S 128 and pressure p 126 are the natural variables for the enthalpy 124h. Temperature T 125 and pressure p 126 are the natural variables for the Gibbs free energy g 122. The conversions between different fundamental states are represented by the arrows and the labels besides the arrows. In particular, g=α+pv, u=α+TS, h=u+pv, and h=g+TS. As an example, suppose the primary manifold is established using the Helmholtz energy α, and the inputs are T and v. Then after determining S and p using the additional manifolds, the enthalpy is given by h=α+pv+TS.

In one embodiment of the invention, the Helmholtz energy is used to generate the primary manifold, and subsequently the secondary manifolds. Other embodiments use the Gibbs free energy, the enthalpy, and the internal energy.

FIG. 1D shows a block diagram of a system and a method 100 for determining a value 180 of a thermodynamic parameter of a substance according to some embodiments of the invention. The system and the method can be implemented using a processor 130.

A set of secondary manifolds 145 is acquired 140 and stored, e.g., in a memory 147. The set of secondary manifold can be determined offline, as discussed below. Each secondary manifold represents a mapping among values of a combination of the thermodynamic parameters of the substance, and is generated based on the primary manifold representing a mapping between the pair of thermodynamic parameters and a thermodynamic potential. In addition, the primary manifold can also be acquired.

In some embodiments, each secondary manifold is determined for unique combination of the thermodynamic parameters of the substance, and all combinations are determined from the single primary manifold to ensure mutual consistence of the thermodynamic parameters. Also, in some embodiments, the secondary manifolds are predetermined, and particular secondary manifold 155 is selected 150 based on particular thermodynamic parameters provided to determine the value of the thermodynamic parameter of interest. For example, measurements 175 of the particular thermodynamic parameters can be acquired by one or more sensors 170 during an operation of a thermodynamic system having a substance such as working fluid. Accordingly, in one embodiment, the particular thermodynamic parameters are parameters to be measured during an operation of a thermodynamic system. However, any other method of selection of the particular thermodynamic parameters is possible. The thermodynamic system can include the processor 130 for executing the method 100. Next, the value 180 of the thermodynamic parameter is determined 160 based on the particular secondary manifold 155 and values of the particular thermodynamic parameters 175, as described above.

In one embodiment, bi-cubic functions are used to represent the thermodynamic potential for a particular single substance fluid in vapor or liquid phase. This embodiment is described in more details below for illustration purposes.

In this embodiment, a uniform mesh is generated on a region of interest in the T−v plane, where T is the temperature, and v is the specific volume. On each grid cell (tᵢ,tᵢ₊₁)×(vⱼ,vⱼ₊₁) of the mesh, the manifold of the Helmholtz energy α is represented by a bi-cubic function Φ_{i,j} as follows:

$${Φ}_{i , j} ( T , v ) = {\sum }_{k = 0}^{3} {\sum }_{l = 0}^{3} {{α}_{i , j , kl} ( T - {t}_{i} )}^{k} {( v - {v}_{j} )}^{l} \qquad ( 1 )$$

for (T,v)ε(tᵢ,tᵢ₊₁)×(vⱼ,vⱼ₊₁). The 16 unknown coefficients α_{i,j,kl} can be determined from a set of 16 equations, which are listed below

$${Φ}_{i , j} ( {t}_{i} , {v}_{j} ) = a ( {t}_{i} , {v}_{j} )$$

$${Φ}_{i , j} ( {t}_{i + 1} , {v}_{j} ) = a ( {t}_{i + 1} , {v}_{j} )$$

$${Φ}_{i , j} ( {t}_{i} , {v}_{j + 1} ) = a ( {t}_{i} , {v}_{j + 1} )$$

$${Φ}_{i , j} ( {t}_{i + 1} , {v}_{j + 1} ) = a ( {t}_{i + 1} , {v}_{j + 1} )$$

$$\frac{\partial {Φ}_{i , j}}{\partial T} ( {t}_{i} , {v}_{j} ) = \frac{\partial {a}_{i , j}}{\partial T} ( {t}_{i} , {v}_{j} )$$

$$\frac{\partial {Φ}_{i , j}}{\partial T} ( {t}_{i + 1} , {v}_{j} ) = \frac{\partial {a}_{i , j}}{\partial T} ( {t}_{i + 1} , {v}_{j} )$$

$$\frac{\partial {Φ}_{i , j}}{\partial T} ( {t}_{i} , {v}_{j + 1} ) = \frac{\partial {a}_{i , j}}{\partial T} ( {t}_{i} , {v}_{j + 1} )$$

$$\frac{\partial {Φ}_{i , j}}{\partial T} ( {t}_{i + 1} , {v}_{j + 1} ) = \frac{\partial {a}_{i , j}}{\partial T} ( {t}_{i + 1} , {v}_{j + 1} )$$

$$\frac{\partial {Φ}_{i , j}}{\partial v} ( {t}_{i} , {v}_{j} ) = \frac{\partial {a}_{i , j}}{\partial v} ( {t}_{i} , {v}_{j} )$$

$$\frac{\partial {Φ}_{i , j}}{\partial v} ( {t}_{i + 1} , {v}_{j} ) = \frac{\partial {a}_{i , j}}{\partial T} ( {t}_{i + 1} , {v}_{j} )$$

$$\frac{\partial {Φ}_{i , j}}{\partial v} ( {t}_{i} , {v}_{j + 1} ) = \frac{\partial {a}_{i , j}}{\partial v} ( {t}_{i} , {v}_{j + 1} )$$

$$\frac{\partial {Φ}_{i , j}}{\partial v} ( {t}_{i + 1} , {v}_{j + 1} ) = \frac{\partial {a}_{i , j}}{\partial v} ( {t}_{i + 1} , {v}_{j + 1} )$$

$$\frac{{\partial }^{2} {Φ}_{i , j}}{\partial T \partial v} ( {t}_{i} , {v}_{j} ) = \frac{\partial {a}_{i , j}}{\partial T \partial v} ( {t}_{i} , {v}_{j} )$$

$$\frac{{\partial }^{2} {Φ}_{i , j}}{\partial T \partial v} ( {t}_{i + 1} , {v}_{j} ) = \frac{\partial {a}_{i , j}}{\partial T \partial v} ( {t}_{i + 1} , {v}_{j} )$$

$$\frac{{\partial }^{2} {Φ}_{i , j}}{\partial T \partial v} ( {t}_{i} , {v}_{j + 1} ) = \frac{\partial {a}_{i , j}}{\partial T \partial v} ( {t}_{i} , {v}_{j + 1} )$$

$$\frac{{\partial }^{2} {Φ}_{i , j}}{\partial T \partial v} ( {t}_{i + 1} , {v}_{j + 1} ) = \frac{\partial {a}_{i , j}}{\partial T \partial v} ( {t}_{i + 1} , {v}_{j + 1} )$$

The Helmholtz energy and its derivatives in the right-hand-sides of the above equations are determined using the fundamental EOS. After these quantities are determined, α_{i,j,kl} are solved using algebraic determinations. This

can be accomplished because the above equations contain only 16 unknowns α_{i,j,kl}, k=0,1,2,3 and l=0,1,2,3, and are linear.

Equation (1) can be written in a matrix form as

$$\begin{matrix}{Φ}_{i , j} ( T , v ) = {Φ}_{i , j} ( τ , w ) \\ = [ \begin{matrix}1 & τ & {τ}^{2} & {τ}^{3}\end{matrix} ] [ \begin{matrix}{a}_{i , j , 00} & {a}_{i , j , 01} & {a}_{i , j , 02} & {a}_{i , j , 03} \\ {a}_{i , j , 10} & {a}_{i , j , 11} & {a}_{i , j , 12} & {a}_{i , j , 13} \\ {a}_{i , j , 20} & {a}_{i , j , 21} & {a}_{i , j , 22} & {a}_{i , j , 23} \\ {a}_{i , j , 30} & {a}_{i , j , 31} & {a}_{i , j , 32} & {a}_{i , j , 33}\end{matrix} ] [ \begin{matrix}1 \\ w \\ {w}^{2} \\ {w}^{3}\end{matrix} ]\end{matrix} \qquad ( 2 )$$

where τ=T−tᵢ, w=v−vⱼ.

Using the bi-cubic representation of the Helmholtz energy in equation (2), the mappings between different thermodynamic parameters can be constructed. Some of these mappings are described below:

The Mapping (T,v)→p

The relation between the Helmholtz energy α and the pressure is described by the following expression

$$p ( T , v ) = - \frac{\partial a ( t , v )}{\partial v} .$$

Therefore, by taking the derivative of equation (2) with respect to the specific volume v, the mapping from (T,v) to the pressure p can be constructed as:

$$\begin{matrix}p ( T , v ) = - \frac{\partial {Φ}_{i , j} ( T , v )}{\partial v} \\ = - \frac{\partial {Φ}_{i , j} ( τ , w )}{\partial w} \\ = - [ \begin{matrix}1 & τ & {τ}^{2} & {τ}^{3}\end{matrix} ] [ \begin{matrix}{a}_{i , j , 01} & {a}_{i , j , 02} & {a}_{i , j , 03} \\ {a}_{i , j , 11} & {a}_{i , j , 12} & {a}_{i , j , 13} \\ {a}_{i , j , 21} & {a}_{i , j , 22} & {a}_{i , j , 23} \\ {a}_{i , j , 31} & {a}_{i , j , 32} & {a}_{i , j , 33}\end{matrix} ] [ \begin{matrix}1 \\ 2 w \\ 3 {w}^{2}\end{matrix} ]\end{matrix}$$

The Mapping (T,v)→S

From the LOS, the specific entropy is

$$S ( T , v ) = - \frac{\partial a ( T , v )}{\partial T} .$$

Therefore the mapping from (T,v) to the specific entropys can be constructed as:

$$\begin{matrix}S ( T , v ) = - \frac{\partial {Φ}_{i , j} ( T , v )}{\partial T} \\ = - \frac{\partial {Φ}_{i , j} ( τ , w )}{\partial τ} \\ = [ \begin{matrix}1 & 2 τ & 3 {τ}^{2}\end{matrix} ] [ \begin{matrix}{a}_{i , j , 10} & {a}_{i , j , 11} & {a}_{i , j , 12} & {a}_{i , j , 13} \\ {a}_{i , j , 20} & {a}_{i , j , 21} & {a}_{i , j , 22} & {a}_{i , j , 23} \\ {a}_{i , j , 30} & {a}_{i , j , 31} & {a}_{i , j , 32} & {a}_{i , j , 33}\end{matrix} ] [ \begin{matrix}1 \\ w \\ {w}^{2} \\ {w}^{3}\end{matrix} ]\end{matrix}$$

The Mapping (p,T)→v

From the mapping (T,v)→p, for any fixed T,p is a quadratic function in v. Therefore, v can be determined by finding the square root of the quadratic function. In particular, let

cᵥ₂(T)=3α_{i,j,33}τ³+3α_{i,j,23}τ²+3α_{i,j,13}τ+3α_{i,j,03},

cᵥ₁(T)=3α_{i,j,32}τ³+3α_{i,j,22}τ²+3α_{i,j,12}τ+3α_{i,j,02}, and

cᵥ₀(T,p)=3α_{i,j,31}τ³+3α_{i,j,21}τ²+3α_{i,j,11}τ+3α_{i,j,01}+p, then p and v satisfy the following equation

cᵥ₂(T)w²=cᵥ₁(T)w+cᵥ₀(T,p)=0.

Hence v is given by

$$v = {v}_{j} + w = {v}_{j} + \frac{- {c}_{v 1} ( T ) + \sqrt{{c}_{v 1}^{2} ( T ) - 4 {c}_{v 2} ( T ) {c}_{v 0} ( T , p )}}{2 {c}_{v 2} ( T )} .$$

The other square root is omitted because it does not have a physical meaning.

The Mapping (S,v)→T

Similar to the construction of the mapping (p,T)→v, the mapping (S,v)→t can be constructed as follows

$$T = {t}_{j} + τ = {t}_{j} + \frac{- {c}_{τ 1} ( W ) + \sqrt{{c}_{τ 1}^{2} ( W ) - 4 {c}_{τ 2} ( W ) {c}_{τ 0} ( S , w )}}{2 {c}_{τ 2} ( W )}$$

where c_{τ2}(w)=3α_{i,j,33}τ³+3α_{i,j,32}τ²+3α_{i,j,31}τ+3α_{i,j,30},

c_{τ1}(w)=3α_{i,j,23}τ³+3α_{i,j,22}τ²+3α_{i,j,21}τ+3α_{i,j,20},

c_{τ0}(S,w)=3α_{i,j,13}τ³+3α_{i,j,12}τ²+3α_{i,j,11}τ+3α_{i,j,10}+S.

The Mappings (S,p)→T and (S,p)→v

Unlike other mappings described above, the mappings (S,p)→T and (S,p)→v cannot be constructed using explicit expressions. In one embodiment, Newton's method is used to establish these mappings. In particular, let f, denote the mapping from (τ,w) to p, and let fₛ denote the mapping from (τ,w) to s, which can be obtained using the above constructed mappings (T,v)→p and (T,v)→S. Then, the mappings (S,p)→T and (S,p)→v can be established by solving the following equation

$$f ( τ , w ) = [ \begin{matrix}{f}_{p} ( τ , w ) - p \\ {f}_{s} ( τ , w ) - S\end{matrix} ] = [ \begin{matrix}0 \\ 0\end{matrix} ] . \qquad ( 3 )$$

Let τₖ, wₖ be the estimated square root values of equation (3) in the k^{th} step, then the Newton's method for the (k+1)^{th} step is

$$\begin{matrix}[ \begin{matrix}{τ}_{k + 1} \\ {w}_{k + 1}\end{matrix} ] = [ \begin{matrix}{τ}_{k} \\ {w}_{k}\end{matrix} ] - ∇ {f}^{- 1} ( {τ}_{k} , {w}_{k} ) f ( {τ}_{k} , {w}_{k} ) \\ = [ \begin{matrix}{τ}_{k} \\ {w}_{k}\end{matrix} ] - {[ \begin{matrix}\frac{\partial {f}_{p} ( {τ}_{k} , {w}_{k} )}{\partial τ} & \frac{\partial {f}_{p} ( {τ}_{k} , {w}_{k} )}{\partial w} \\ \frac{\partial {f}_{s} ( {τ}_{k} , {w}_{k} )}{\partial τ} & \frac{\partial {f}_{s} ( {τ}_{k} , {w}_{k} )}{\partial w}\end{matrix} ]}^{- 1} f ( {τ}_{k} , {w}_{k} ) \\ = [ \begin{matrix}{τ}_{k} \\ {w}_{k}\end{matrix} ] - {[ \begin{matrix}\frac{{\partial }^{2} {Φ}_{i , j} ( {τ}_{k} , {w}_{k} )}{\partial τ \partial w} & \frac{{\partial }^{2} {Φ}_{i , j} ( {τ}_{k} , {w}_{k} )}{\partial {w}^{2}} \\ \frac{{\partial }^{2} {Φ}_{i , j} ( {τ}_{k} , {w}_{k} )}{\partial {τ}^{2}} & \frac{{\partial }^{2} {Φ}_{i , j} ( {τ}_{k} , {w}_{k} )}{\partial τ \partial w}\end{matrix} ]}^{- 1} f ( {τ}_{k} , {w}_{k} )\end{matrix}$$

From equation (2), the entries of Δf(τₖ,wₖ) can be easily determined as follows:

$$\frac{{\partial }^{2} {φ}_{i , j} ( {τ}_{k} , {w}_{k} )}{\partial τ \partial w} = - [ \begin{matrix}1 & 2 {τ}_{k} & 3 {τ}_{k}^{2}\end{matrix} ] [ \begin{matrix}{a}_{i , j , 11} & {a}_{i , j , 12} & {a}_{i , j , 1 , 3} \\ {a}_{i , j , 21} & {a}_{i , j , 22} & {a}_{i , j , 23} \\ {a}_{i , j , 31} & {a}_{i , j , 32} & {a}_{i , j , 33}\end{matrix} ] [ \begin{matrix}1 \\ 2 {w}_{k} \\ 3 {w}_{k}^{2}\end{matrix} ]$$

$$\frac{{\partial }^{2} {φ}_{i , j} ( {τ}_{k} , {w}_{k} )}{\partial {w}^{2}} = - [ \begin{matrix}1 & {τ}_{k} & {τ}_{k}^{2} & {τ}_{k}^{3}\end{matrix} ] [ \begin{matrix}{a}_{i , j , 02} & {a}_{i , j , 03} \\ {a}_{i , j , 12} & {a}_{i , j , 13} \\ {a}_{i , j , 22} & {a}_{i , j , 23} \\ {a}_{i , j , 32} & {a}_{i , j , 33}\end{matrix} ] [ \begin{matrix}2 \\ 6 {w}_{k}\end{matrix} ]$$

$$\frac{{\partial }^{2} {φ}_{i , j} ( {τ}_{k} , {w}_{k} )}{\partial {τ}^{2}} = - [ \begin{matrix}2 & 6 {τ}_{k}\end{matrix} ] [ \begin{matrix}{a}_{i , j , 20} & {a}_{i , j , 21} & {a}_{i , j , 22} & {a}_{i , j , 23} \\ {a}_{i , j , 30} & {a}_{i , j , 31} & {a}_{i , j , 32} & {a}_{i , j , 33}\end{matrix} ] [ \begin{matrix}1 \\ {w}_{k} \\ {w}_{k}^{2} \\ {w}_{k}^{3}\end{matrix} ] .$$

The Newton's method is terminated after the error is smaller than a predetermined tolerance. The temperature and specific volume corresponds to the S and p values are determined using T=t₁+τₖ and v=vⱼ+wₖ.

The Determination of the Correct Grid Cell

To determine the desired thermodynamic parameters correctly using mappings described above for any pair of thermodynamic parameter inputs, such as (T,v), (S,v), or (S,p), some embodiments determine the mappings using the grid cell that includes the (T,v) data corresponding to the given inputs. Because the grid cell associated with the pair of thermodynamic parameters is not necessarily known, this embodiment determines the correct cell for the pair of thermodynamic parameters. When the mesh is uniform in the T−v domain, some variations of the embodiment determine the correct cell for mappings (T,v)→p and (T,v)→S.

For the mapping (p,T)→v, the index for the correct cell is determined by the following steps:
1) Determine i such that tᵢ≦T<t₁₊₁. Let Δₜ=tᵢ₊−tᵢ.
2) Search the index j_{c} such that

$$\vert \frac{T - {t}_{i}}{{Δ}_{t}} {F}_{p} ( {t}_{i + 1} , {v}_{{j}_{c}} ) + \frac{{t}_{i + 1} - T}{{Δ}_{t}} {F}_{p} ( {t}_{i} , {v}_{{j}_{c}} ) - p \vert$$

is the smallest among all possible choices of j_{c}.
3) If Fₚ(T,vⱼ_{_{c}})>p, then j=j_{c}=1. Otherwise, j=j_{c}. Then the index of the correct cell is {i,j}.

Here, Fₚ denotes the mapping (T,v)→p. The second step above is based on a linear approximation of the function Fₚ's dependence on the specific volume. j_{c} typically provides a good estimation of the index of the correct grid cell. Because

$${( \frac{d p}{d v} )}_{T}$$

is strictly negative, the third step above yields the index of the grid with Fₚ(T,vⱼ)≧p>Fₚ(T,vⱼ₊₁). By the continuity of fₚ, it can be concluded that there exists vε[vⱼ,vⱼ₊₁), such that fₚ(T,v)=p, which ensures that {i,j} is the index of the correct grid cell.

In a similar manner, the index {i,j} of the correct grid cell for constructing the mapping (S,v)→p can be determined by following the steps:
1) Determine j such that vⱼ<vⱼ₊₁. Let Δᵥ=vⱼ₊₁−v₃.
2) Search the index i_{c} such that

$$\vert \frac{{v}_{j + 1} - v}{{Δ}_{v}} {F}_{S} ( {t}_{ic} , {v}_{j} ) + \frac{v - {v}_{j}}{{Δ}_{v}} {F}_{S} ( {t}_{ic} , {v}_{j + 1} ) - S \vert$$

is the smallest of all possible choices of i_{c}.
3) If F_{S}(tᵢ_{_{c}},v)>S, then i=i_{c}. Otherwise, i=i_{c}−1. The index of the correct cell is {i,j}.

Here Fₛ denotes the mapping (T,v)→S. Since the mappings (S,p)→T and (S,p)→v are established using the Newton's method, the correct cells can be determined automatically.

### EXAMPLE

Here is an example of a particular application of the proposed method for the determination of enthalpy h of the refrigerant vapor flowing out the compressor in an air conditioning system. Such a task is crucial for evaluating the cooling/heating capacity as well as the energy efficiency of the air conditioning system.

The enthalpy cannot be measured directly and, thus, the enthalpy is calculated using certain measured thermodynamic parameters. In this example, the particular thermodynamic parameters to be measured are the temperature T, and the pressure p. Suppose that the Helmholtz energy has been used to establish the primary manifold using bi-cubic interpolations described previously, then the specific volume v can be readily determined using the mapping (p,T)→v, which has been described previously. Such a calculation is accomplished using one of the secondary manifolds. After the specific volume v has been determined, the value of the Helmholtz energy is determined using the primary manifold given the calculated specific volume v and measured temperature T, and the entropy S is also readily calculated using the mapping (T,v)→S using another secondary manifold. Finally, the enthalpy is determined by the thermodynamic relation h=α+TS+pv.

Offline and Real Time Determinations

In some embodiments of the invention, the determinations of the thermodynamic parameter are partitioned into two parts, e.g., the offline part and the real time part.

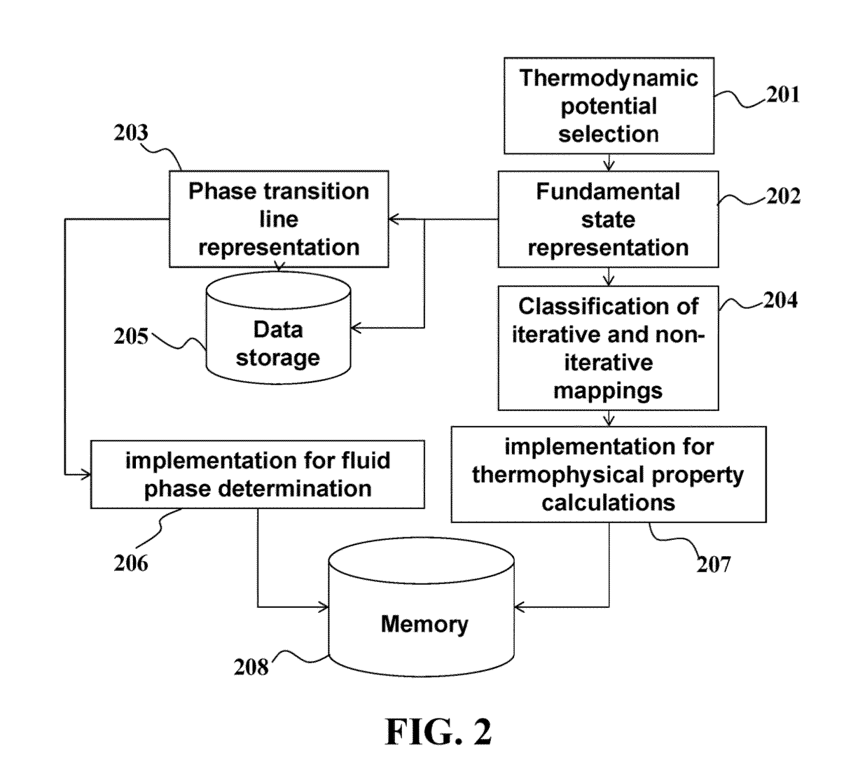

FIG. 2 is a block diagram describing the offline procedures in this embodiment. In block 201, one out of the four thermodynamic potential is selected to facilitate thermodynamic parameter determinations for the specific thermodynamic process. In block 202, the selected thermodynamic potential is represented in a region of interest. Bi-cubic representation of the thermodynamic potential on a uniform mesh as described above in an embodiment is one example of such representation. The data necessary for the evaluation of the representation of the thermodynamic potential are stored in at least one memory device, as shown in block 205. Based on the representation of the thermodynamic potential and theory of thermodynamics, all desired mappings between thermodynamic parameters are classified into iterative mappings and non-iterative mappings, each of which is implemented as a computer program in the procedure corresponding to block 207.

The thermodynamic parameter calculation programs are stored in a memory device as described in block 208. In the procedure represented by block 207, a switcher program is generated for linking the correct thermodynamic parameter calculation program to the type of calculation determined by desired inputs and outputs. The switcher program is stored in at least one memory device as described by block 208. In block 203, the phase transition lines in the domain of natural variables (including the line between liquid and mixture of liquid and vapor, the line between vapor and mixture of vapor and liquid, and the line between liquid and supercritical vapor) are determined. These lines are represented using various appropriate methods, such as polynomials or spline functions, and the data for these representations are stored in at least one memory device, as shown in block 205. In the procedure corresponding to block 206, a computer program is generated for testing the phase of the working fluid based on thermodynamic data inputs, and this program is stored in at least one memory device 208.

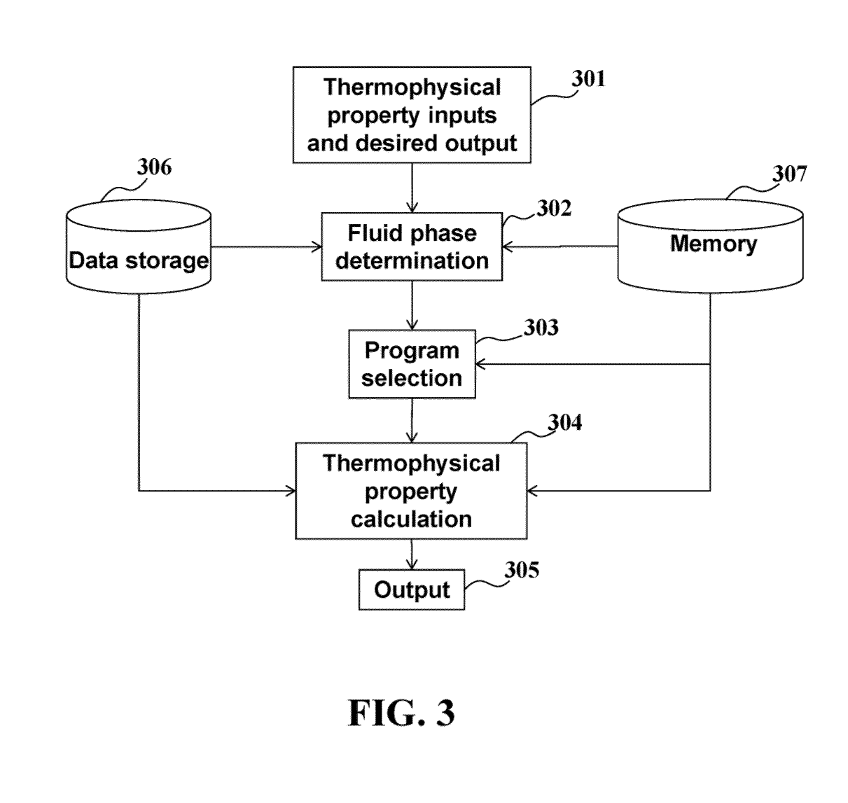

FIG. 3 is a block diagram describing the real time procedures of the embodiment. The procedure is initiated by the thermodynamic parameter input values as well as the desired output thermodynamic parameter, which is shown in block 301. In the procedure represented by block 302, the phase of the working fluid corresponding to the thermodynamic parameter input values is decided using data in block 306 and the phase determination program stored in block 307. The content in block 306 can be same as that of the data storage block 205 in FIG. 2. The content in the computer program storage block 307 can be the same as that of the block 208 in FIG. 2. After the phase of the working fluid is determined, the proper program for the desired thermodynamic parameter determination is selected in block 303, using the switcher program generated in block 207 in the offline procedures, which has been stored in a memory 307. In the procedure corresponding to block 304, the desired thermodynamic parameter is determined using the program selected from those in the memory 307 and data in block 306, and the result is passed to block 305 for output to simulation, estimation, optimization, or control of the thermodynamic process.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, minicomputer, or a tablet computer. Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. In this respect, the invention may be embodied as a computer readable storage medium or multiple computer readable media, e.g., a computer memory, compact discs (CD), optical discs, digital video disks (DVD), magnetic tapes, and flash memories. Alternatively or additionally, the invention may be embodied as a computer readable medium other than a computer-readable storage medium, such as a propagating signal.

The terms “program” or “software” are used herein in as generic sense to refer to any type of computer code or set of computer-executable instructions that can be employed to program a computer or other processor to implement various aspects of the present invention as discussed above.

Computer-executable instructions may be in many forms, such as program modules, executed by one or more computers or other devices. Generally, program modules include routines, programs, objects, components, data structures that perform particular tasks or implement particular abstract data types. Typically the functionality of the program modules may be combined or distributed as desired in various embodiments.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for determining a value of a thermodynamic parameter of a substance, comprising:
acquiring a set of secondary manifolds, wherein each secondary manifold represents a mapping among a combination of thermodynamic parameters of the substance, and wherein the mapping is based on a primary manifold representing a mapping between a pair of thermodynamic parameters and a thermodynamic potential;
selecting a particular secondary manifold from the set of secondary manifolds based on particular thermodynamic parameters, wherein the particular secondary manifold is a mapping between the particular thermodynamic parameters and the thermodynamic parameter; and
determining the value of the thermodynamic parameter based on the particular secondary manifold and values of the particular thermodynamic parameters, wherein steps of the method are performed by a processor.

2. The method of claim 1, wherein the substance is a single phase substance, further comprising:
testing a correspondence of the values of the particular thermodynamic parameters to the phase of the substance.

3. The method of claim 1, further comprising:
determining the primary manifold based on a model of the substance; and
generating the secondary manifold by transforming the primary manifold into coordinate system of the combination of the thermodynamic parameters.

4. The method of claim 3, wherein the combination is unique, and wherein the generating comprises:
transforming the primary manifold into the secondary manifold using a theory of thermodynamics.

5. The method of claim 4, wherein the transforming is non-iterative.

6. The method of claim 1, wherein the thermodynamic potential is selected from a group consisting of a Helmholtz energy, a Gibbs free energy, an enthalpy, and an internal energy.

7. The method of claim 4, wherein the transforming is based on a bi-cubic manifold representation of the thermodynamic potential.

8. The method of claim 1, further comprising:
measuring the values of the particular thermodynamic parameters.

9. The method of claim 1, wherein values of the set of secondary manifolds are mutually consistent.

10. A method for determining a value of thermodynamic parameter of a substance, comprising:
generating, based on a model of the substance, a primary manifold of a thermodynamic potential of the substance;
transforming the primary manifold into a set of secondary manifolds using a theory of thermodynamics, wherein each secondary manifold represents a mapping among a combination of thermodynamic parameters of the substance; and
determining the value of the thermodynamic parameter based on measurements of thermodynamic parameters and at least one secondary manifold, wherein steps of the method are performed by a processor.

11. The method of claim 10, wherein values of the set of secondary manifolds are mutually consistent.

12. A thermodynamic system having a working fluid, comprising:
at least one sensor for measuring particular thermodynamic parameters to produce at least one measurement;
a memory storing a set of secondary manifolds, wherein each secondary manifold represents a mapping among a combination of thermodynamic parameters of the substance, and is generated based on a primary manifold of a thermodynamic potential of the substance; and
a processor for determining a value of a thermodynamic parameter based on the measurement, the primary manifold and at least one secondary manifold.

13. The system of claim 12, wherein processor selects the secondary manifold based on the measurement.

14. The system of claim 12, wherein values of the set of secondary manifolds are mutually consistent.
